(19) United States
(12) Patent Application Publication
(10) Pub. No.: US 2014/0229391 A1
(43) Pub. Date: Aug. 14, 2014

(54) PREDICTIVE SERVICE TIMELINE

(71) Applicant: XTime, Inc., Redwood Shores, CA (US)

(72) Inventors: H. Neal East, III, Half Moon Bay, CA (US); Matthew Wyman, Half Moon Bay, CA (US); Adam David Springer, San Ramon, CA (US); Adam R. Galper, Palo Alto, CA (US)

(73) Assignee: XTime, Inc., Redwood Shores, CA (US)

(21) Appl. No.: 14/158,647

(22) Filed: Jan. 17, 2014

Related U.S. Application Data
(60) Provisional application No. 61/762,485, filed on Feb. 8, 2013.

(51) Int. Cl. G06Q 10/00

(52) U.S. Cl. CPC G06Q 10/20
USPC 705/305

(57) ABSTRACT

Approaches for generating and displaying a predictive service timeline are provided wherein a plurality of graphical interface elements is generated based on past and future service events and the plurality of graphical interface elements is caused to be displayed along a graphical timeline, wherein the graphical interface elements are associated with dates on the graphical timeline.

### CLAIM OF PRIORITY AND RELATED APPLICATION DATA

This application claims priority to U.S. Provisional patent application Ser. No. 61/762,485, filed on Feb. 8, 2013, the contents of which are hereby incorporated by reference for all purposes as if fully set forth herein.

### TECHNICAL FIELD

The subject matter disclosed herein generally relates to the processing of data. Specifically, the present disclosure addresses systems, devices, and methods directed to predictive service timeline approaches.

### BACKGROUND

One of the most ubiquitous items in a person's life is their automobile. Every morning, millions of Americans commute to and from work in their car. Later, they might take their car to go out in the evening. The automobile enables untold amounts of commerce, allowing people to work as well as buy and sell goods in a wide geographic area.

Planning, tracking, and obtaining service and maintenance of a car is left to widely disparate means, even in the current digital age. Many car owners rely upon mass-mailers from car dealers to tell them when recommended service is needed, or glance at a sticker on the windshield to see if the oil needs changing. Determining what services one has already purchased requires going through dense, technical receipts and storing them for future perusal, while planning future services often involves finding the car's “owner's manual” to look up the manufacturer's recommended service intervals, which may not be best suited for all environments and situations.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a flow diagram 100 illustrating the functional steps of generating and displaying a predictive service timeline, according to some embodiments;

FIG. 2 is a view of a user interface 200 for viewing a predictive service timeline, according to some embodiments;

FIG. 3 is another view of a user interface 300 for viewing a predictive service timeline, according to some embodiments;

FIG. 4 is a block diagram 400 illustrating aspects of a system for generating and displaying a predictive service timeline, according to some embodiments;

FIG. 5 is a block diagram 500 illustrating components of a machine, according to some example embodiments, able to read instructions from a machine-readable medium and perform any one or more of the methodologies discussed herein.

### DETAILED DESCRIPTION OF THE INVENTION

Approaches for generating and displaying a predictive service timeline are presented herein. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details. In other instances, well-known structures and devices are shown in block diagram form or discussed at a high level in order to avoid unnecessarily obscuring teachings of embodiments of the invention.

In an embodiment, an approach is described for methods, systems, devices, and non-transitory machine-readable storage medium that cause a machine to receiving a request to view service information for a vehicle, and retrieving data associated with the vehicle based on the request, wherein the data comprises at least one past service event associated with the vehicle. Then, a plurality of future service events based on the data is determined, and a plurality of graphical interface elements is generated based on the at least one past service event and the plurality of future service events, and the plurality of graphical interface elements is caused to be displayed along a graphical timeline, wherein the graphical interface elements are associated with dates on the graphical timeline.

### Predictive Service Timeline

Embodiments of the predictive service timeline process data and utilize predictive approaches to produce information that is presented in a user interface display that combines large amounts of data into a single visualization. In an example embodiment, data may be ingested, processed and stored by a system, and this data may range from the repair history of a specific vehicle, current information related to the vehicle, information about future recommended services for the vehicle, etc., as described herein. For purposes of this disclosure, the terms “car,” “automobile,” and “vehicle” may be used interchangeably, as the techniques described herein are applicable to any type of vehicle or conveyance.

Data about a car's past service history may be received from any number of sources; for example, by searching and retrieving data from a server as well as connecting over a network to databases maintained by third parties, or it may be entered by hand into a database that is communicatively coupled to a system embodying an example embodiment.

Data received concerning past service events may be of any scope; for example, the data may describe the car, date(s) of service, the type(s) of services performed (which may include various dealer codes that may be translated into a descriptive narrative), the cost of said services, and any other type of information. This information is received and curated; that is, it is analyzed, normalized and stored. The data may be received in various fashions. For example, when a car dealer joins the network (i.e., makes its data available to the system in order to participate), all of the Dealer's past repair order (RO) data for vehicles is synchronized, reviewed, collated, and persisted. Subsequently, each RO that is opened and/or modified is automatically synchronized. The dealer's data may be parsed for the data requested for a specific vehicle, for example, by using the VIN as a key value. As part of the normalization process, the data may be edited; for example, the data may include dealer codes, which are replaced with a more user-friendly description.

Additional data used in example embodiments may include customer-specific data, such as demographic information and a “type” of owner determined as described herein. Knowing the geographic location of the owner (and thereby the vehicle being tracked) can help in determining suggested service intervals that may depart from the monolithic schedules often published by automobile manufacturers. For example, an owner living in an area known for high heat and arid conditions may be advised to change air filers more often, while an owner known to live in a metropolitan area known for high levels of stop & go driving and poor road conditions may be advised to change the oil more often and have the tires and suspension looked at more frequently.

Knowing what complaints/services the owner has brought the car in for (as well as how much they have spent on various services) helps in identifying whether an owner is a “self-fixer” type or somebody who prefers to have a dealership do all repairs for him, no matter how minor. Knowing this, as well as other information such as age, income, zip codes, even whether an owner has accepted a loaner car each time she brought the car in for service can assist with generating the unified predictive service timeline as well as with marketing efforts associated with various embodiments.

Additional data used in example embodiments may include the past VIN-specific service history of a vehicle. Customers of a dealership utilizing an embodiment of the techniques described herein may not have purchased their car at that particular dealership; therefore, if data were ingested only describing the past service history of the car at that particular dealership, the larger picture would be missing. By ingesting data concerning the entire lifetime of a specific vehicle, either from third party databases, the user herself (for example through a questionnaire), or other sources, more accurate predictions may be achieved.

Additional data used in example embodiments may include manufacturer recommendations; for example, the entire recommended maintenance schedule for every automobile on the market in every trim and style. In an example embodiment, these recommended schedules provide a baseline that is analyzed in concert with other data (such as that described herein) to predict and suggest service events occurring in the future.

Additional data used in example embodiments may include third party data integration. For example, an owner may get her oil changed, tires replaced, battery changed, etc. at any number of retail establishments. Being able to import this data, for example by connecting to a database or ingesting the data in another fashion, enables more accurate predictive service suggestions. Knowing that a customer had her tires changed at 50,000 miles at a Costco rather than at the recommended 60,000 miles at the dealership may be used to provide a more personalized 60,000-mile service reminder via the unified predictive service timeline.

Additional data used in example embodiments may include related VIN service history for a particular car. For example, vehicles like the one under consideration have had particular services performed at a particular time or mileage. This may be the commonly-known “lemon” factor, but can also take recalls into account, as well as cars made by different manufacturers that share a common element, design or otherwise. Additional data points may include geographic data (e.g., vehicles in Colorado vs. California).

Example embodiments utilize the concept of a “cohort,” which in one example is a group representing a segment of the population which may be classified based upon criteria such as demographics (e.g., income levels, geography, etc.). In an example, higher income owners may perform basic services such as oil changes more often. Similarly, the same Year/Make/Model truck may be used in a very different manner from one segment to another based on economic and demographic classifications. In another example, buying patterns and social network connections may be predictive of service behaviors. Another example would be the likelihood of a cohort to purchase a specific brand of tire or to have an oil change done based on cost and or social network experience with the dealer (e.g., reviews).

Additional data used in example embodiments may include real-time data such as manufacturer-provided real-time vehicle-generated diagnostic trouble codes. Modern automobiles have sophisticated sensors and processors, and can often diagnose current trouble as well as identify failing components. When events of this nature occur, the vehicle sensors send alert signals to the processing modules. These codes may be read, translated and transmitted, such as over a wired or wireless network. An example embodiment ingests codes generated from a particular vehicle and transmitted over a network. As will be discussed, said codes may be used to help generate the predictive service timeline by highlighting specific service needs and likely service events.

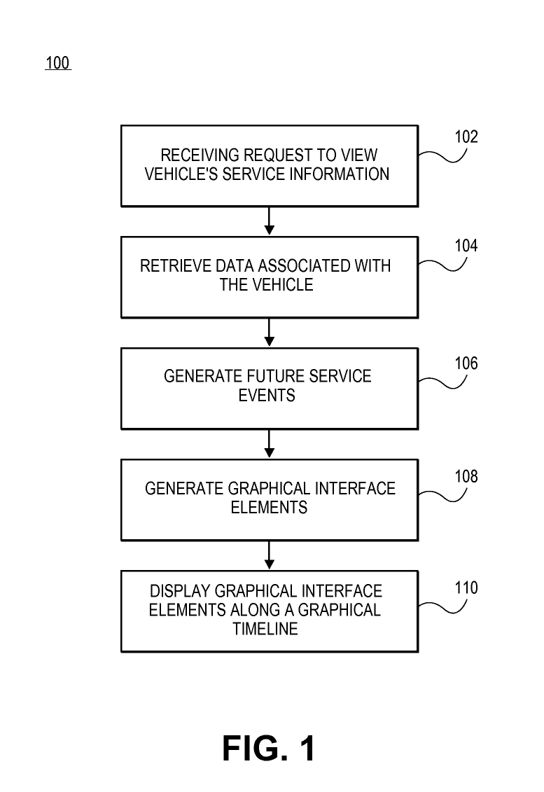

FIG. 1 is a flow diagram 100 illustrating the functional steps of generating and displaying a predictive service timeline. In some implementations, the process illustrated by FIG. 1 can include fewer, additional and/or different operations. In other examples, only one or some subset of these operations may be included, as each operation may stand alone, or may be provided in some different order other than that shown in FIG. 1.

At 102, a request is received to view service information for a particular vehicle, wherein “service information” may comprise some or all of the repair and service history for the particular vehicle, such as type of service or repair, dates of service, cost of service, name of service representatives, etc. As an example, a user logs into a web-based system and either inputs a vehicle VIN or other identifying information from which the vehicle VIN can be established.

At 104, data describing all past service events for a specific vehicle are retrieved and stored. The structure of the data being received may be implemented in any number of ways, a common way being to use the car's vehicle identification number (VIN) as the key.

In an example, a VIN for a car is received and data concerning past service events for the car is retrieved from one or more dealer management systems (DMS). This data is analyzed and information relating to a past 15,000-mile and 30,000-mile service is obtained. Further, data is received from a server where information relating to a past 7,500-mile service had been stored after being previously obtained. In some embodiments, data concerning service events as disparate as major maintenance to tire replacements to oil changes may be obtained and stored from third-party servers. A “service event” may comprise any or all of these events, and includes one or more times that the vehicle in question was brought into a dealership or other establishment for repairs, preventive maintenance, part replacement, etc.

At 106, data is generated representing potential future service events. This determination of potential future events is used to populate the service timeline as discussed herein, and is based upon data associated with the vehicle. For example, data comprising past service events may be combined with dates and/or mileage checkpoints to calculate a usage rate, which is then used to map out the expected dates and/or mileage of future service events. Another example may be Vehicle Diagnostic Trouble codes (DTC) that act as early warnings of likely trouble and serve to influence what services should be scheduled on the timeline and when. For example, a series of fluctuating DTCs for water pressure may indicate that the water pump is nearing the end of its life, and the timeline could be adjusted to reflect this. Furthermore, vehicles with water pump issues at a certain mileage may indicate “severe” wear, which then implies a different service frequency in the timeline. Example DTCs may be: “00001 Engine oil” and “00002 Front brakes.” DTCs may vary from one manufacturer to another.

At 108, graphical interface elements are generated that correspond to the past and future service events. In an example, these elements may comprise rectangular “cards” that contain descriptive text about the data they represent. For example, a “card” for a past 30,000-mile service may display the type of service (30,000), the date performed, the cost of the service and the actual mileage of the car when the service was performed. Visual stylings may be used to highlight and/or differentiate various cards; for example, a card representing an overdue future service may be colored red, while cards representing “major” or factory-recommended services such as major checkups may be larger.

In an example embodiment, the cards may receive input, such as with an input device like a mouse click or a finger on a touchscreen, and in response may cause additional information to be displayed or other actions to be taken, such as transferring the information on a future “card” to a scheduling module so that the predicted future service may be scheduled.

At 110, the graphical interface elements are displayed along a graphical timeline, arranged by date. For example, the current date may be represented by a line in the middle of the graphical timeline displayed on a screen, with past service event “cards” being displayed to the left and future service “cards” being displayed to the right, as is further discussed herein.

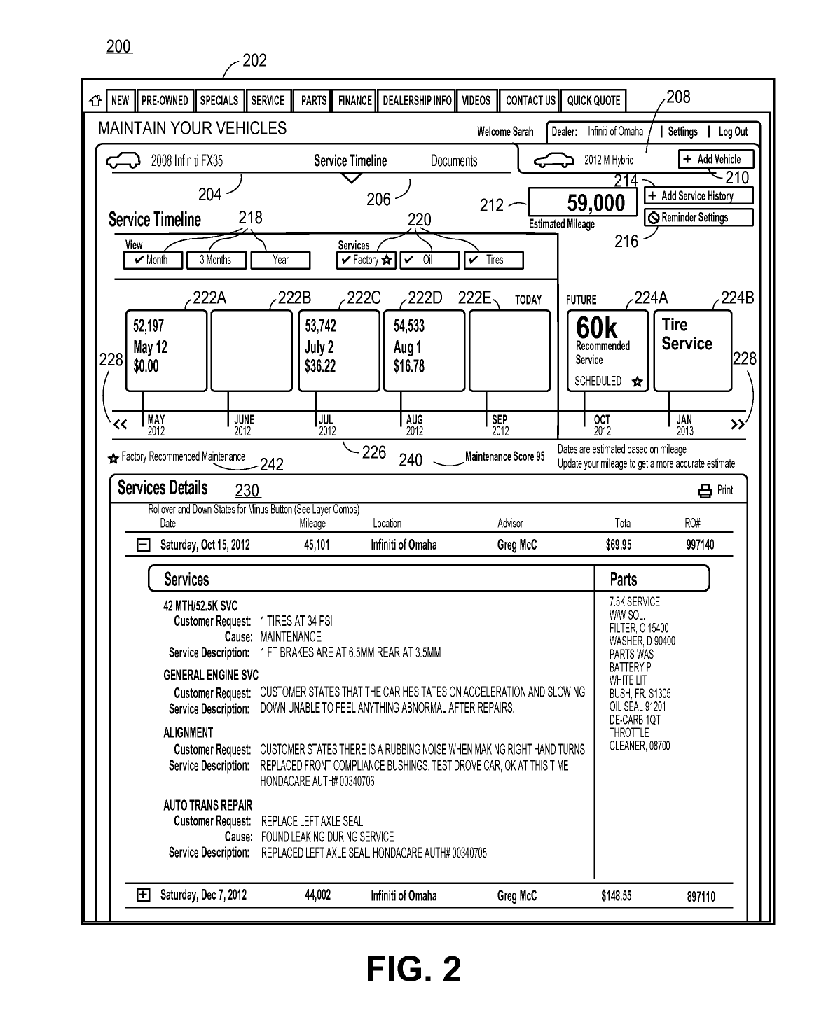

FIG. 2 is a view of a user interface for viewing a predictive service timeline, according to some embodiments. The display 202 upon which the embodiment is generated may comprise a standard monitor, a laptop screen, a touchscreen, or any other type of computer display. It may be displayed via an executable application executed on a computing device or via a web page accessible over a network.

The year, make and model of the currently-selected vehicle 204 is displayed, along with a selection 206 whereby the timeline 226 may be displayed or the information represented by the timeline may be displayed in the form of a list view, for example of service documents.

Other vehicles may be associated with an “account” that includes the currently-selected vehicle, and an interface element displaying these associated vehicles 208 may be displayed, such as in the form of a drop-down menu. An element 210 to add additional vehicles to the account may be displayed.

The current estimated mileage 212 for the vehicle is displayed, said estimated mileage being calculated in one example based upon the actual mileages recorded at past service events and the dates of the events. Through extrapolation using the times and mileages, an estimated mileage may be computed and displayed. In an example embodiment, a user may click on the estimated mileage element 212 and enter the current actual mileage. If so received, then this mileage may be used in future estimated mileage calculations. Interface elements may be displayed for manually adding service history 214 events and setting reminders 216. In the example of manual service events, a user is able to enter service events that were not performed within the Dealer network. These services may include after-market service or “Do-It-Yourself” work such as an oil change. By enabling the consumer to add non-Dealer service events, they will have a more accurate timeline. In the example of manual reminders, reminders are set based generically (e.g., “remind me of all future service events”) or selectively (e.g., “Remind me of the 35,000 mile service”). Reminders help a user remember and orchestrate the work needed on her vehicle.

The service timeline 226 may be viewed in the context of predetermined durations 218, which may be selected by a user, and the timeline 226 is redrawn in response to reflect the requested time constraints. The particular service events 222A-224B displayed on the timeline 226 may be filtered, such as by an interface element 220 that limits the display to a subset of types of events (e.g., factory recommended services, oil changes, tire rotations, etc.)

A graphical timeline 226 is displayed, with the dates being limited to a subset of the entire service history if the service history is too extensive to display every event. Scroll inputs 228 receive input to scroll the timeline forward or backward in time.

The initial view in one example starts with the last five units of historic repair information along with the next two service events. The scrolling behavior is not necessarily strict horizontal scrolling. In one example, the scrolling behavior follows a set of rules. In one example, the scrolling rules may include the following criteria:

1. The user is provided two scrolling affordances—next and last;

2. Scrolling is performed independently in the past (work performed) and future (work projected);

3. At all times, at least two repair blocks and two service blocks are visible;

4. When the user is scrolled to “today,” a single click into the past will cause only the past blocks to animate further into the past. The next two future projected services remain visible.

5. When the user scrolls into the future, the most recent two past blocks remain on the far left no matter how far into the future that the user navigates.

Graphical interface elements 222A-222E (“cards”) representing past service events are arranged on the timeline 226 according to date of service. In an example embodiment, the cards display descriptive information about the service they represent. In an example, the cards may receive input, and in response, the details of the service(s) represented by the card are displayed in a separate section 230 which may provide a more granular view of the data.

Graphical interface elements 224A-224B representing predicted future service events are arranged on the timeline 226 according to predicted future date of service. A maintenance score 240 may be displayed, wherein the score is calculated based upon such factors as frequency of services, portion of services performed on-time, etc. Factory-recommended services may be designated 242 via a special symbol or other graphical presentation.

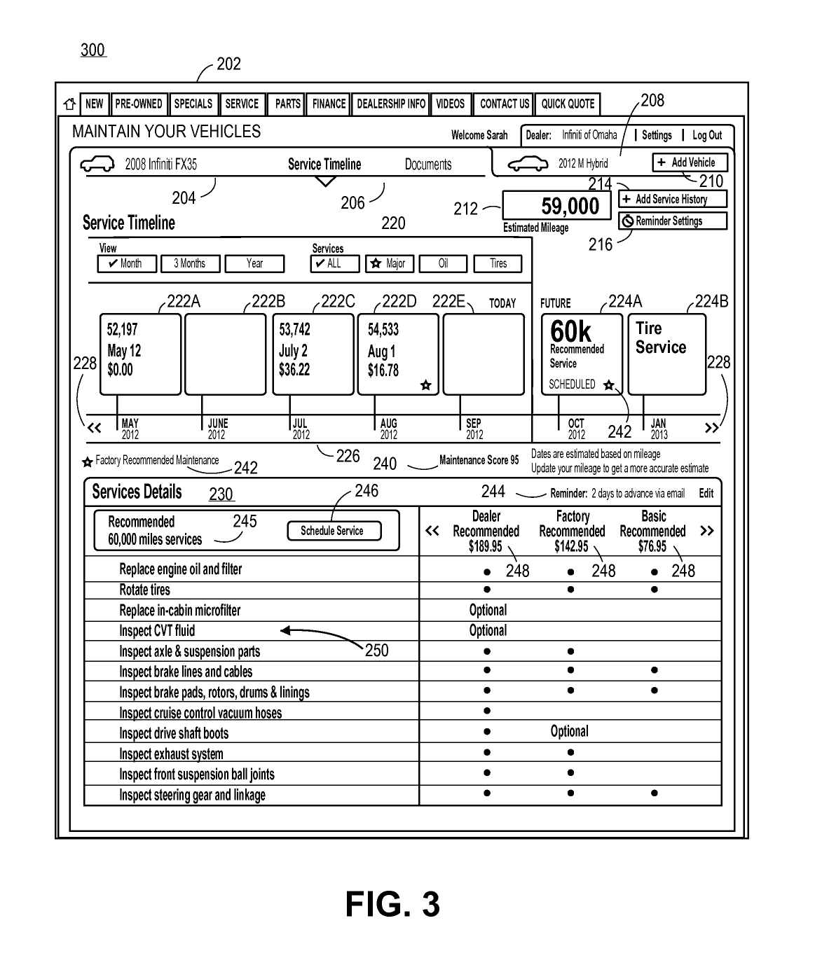

FIG. 3 is a view of a user interface for viewing a predictive service timeline, according to some embodiments. In an example, when a user first acquires a car there may be no past history with which to populate the timeline 226. This could be because the car is new or because a used car has been bought for which no history can be obtained through dealer systems or third-party databases, as described herein. In an example, only predicted future service events 224A-224B may be displayed on the timeline 226, in some instances with reminders 216 associated with them.

These predicted future service events 224A-224B may be generated by manually or electronically obtaining the particular recommended manufacturer service interval for the vehicle and populating these events on the timeline 226. In other cases, dealer-recommended schedules may be utilized, in some examples along with the manufacturer recommendations. In this example, the dealer-recommended service events may be obtained via a database populated by individual dealers; in other examples, it may be acquired via other methods.

In the example of FIG. 3, a recommended maintenance 245 for a future 60,000-mile service event 224A is displayed in the services details 230 area once the graphical indicator for the future 60,000-mile service event 224A is selected. In the services details area 230, a listing of items 250 included in the recommended 60,000 service 245 is presented. This list may be populated from manufacturer and/or dealer schedules, as discussed above. In the event that a particular dealer to which the vehicle is linked in the system has provided their recommended services 248A for various intervals along with pricing, that information may be presented to the user, along with the factory recommended 248B service for the chosen interval. Other services may be displayed, such as a basic service 248C that a dealer may offer for a budget-conscious consumer. A consumer may be offered the opportunity to schedule a service 246 directly from the services details 230 screen, as well as set a reminder 244.

Initially, with a car with no service history available to populate the timeline 226, the timeline may consist of only future service events based on information such as who the owner is (demographic data such as location, job, gender, age, etc.) from which certain predictions may be made, what make/model/year the car is (from which service predictions may be made based on similar cars and what service issues arose and at what mileage), and the maintenance schedule for the car (manufacturer and/or dealer). The future timeline may be populated from such data.

Over time as more data is gathered, such as by the owner filling in information via a website, the owner bringing in the car for service, recall notices, etc., the future maintenance schedule may be predicted with more certainty, and the future service events change to reflect this additional information. The timeline 226 changes over time in this example from a forward-looking schedule based on data such as “people like you” and “cars like yours” to a timeline with data based directly on you and your driving habits and your car's service and repair history (based on data such as repair orders and diagnostic trouble codes).

For example, any new data that is ingested and processed by the system may be used to update and refine the timeline 226. In an example, a predicted future service event of a 20,000-mile service for a person's car may be displayed as being due on December 16. But data is received from the dealership that the person brought the car in for the service on November 16 and the car had 19,000 miles on it. Once this data is received, the 20,000-mile service event is “pinned” to the timeline; that is, it moves from a future predicted service event to a past event that has certainty. Some or all future service events may be updated based on this pinned event.

In this example, calculations may be made based on the date and mileage of the 20,000-mile service to more accurately predict when the owner will bring the car in for the 30,000-mile service. For example, instead of the 30,000-mile service being predicted to be required on December 16 of the following year, it may be adjusted to November 16 of the following year. The mileage may also be taken into account when scheduling future service events, as each time the mileage is updated (e.g., by taking the car into a dealer where they record the actual mileage, or perhaps the owner self-reporting the mileage via a web site), the usage rate of the car may be more accurately calculated. For example, over time, as more data is collected, the system may be able to determine that a particular owner isn't driving the predicted 1,200 miles per month, but instead drives 900 miles per month. Based on this information, and information such as geographic location, weather data, gender, age, occupation, type of car, etc., more accurate predictions may be made as more data is collected on the particular vehicle.

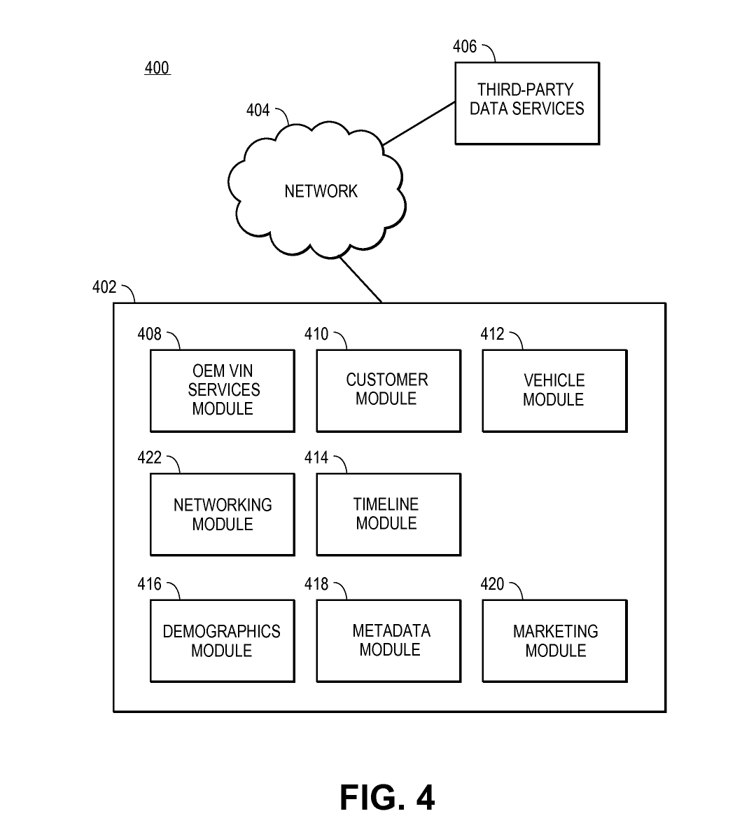

FIG. 4 is a block diagram 400 illustrating components of an example system 402, according to some embodiments. In the example of FIG. 4, the example system 402 is communicatively coupled to a network 404, by which connection may be made to third party data services 406, such as web sites, dealer management systems, manufacturer data systems, and the like, for transmission of data such as that described herein.

The example system 402 comprises multiple modules 408-420 which may be connected such that data may be passed between modules 408-420. A networking module 422 may serve to manage a connection between the example system 402 and the network 404, while in other examples this functionality is contained within one or more other modules. An OEM VIN services module 408 may operate to manage data related to a particular VIN, such as manufacturer recall campaigns, DTCs, driving conditions, vehicle status, and telematics status. A customer module 410 may operate to manage data related to a particular customer, such as personal/demographic data, appointment data (such as appointment history and future appointments), purchase history (of one or more VINs), maintenance frequency, cross-dealer relationships, and customer relationships (such as family members).

A vehicle module 412 may operate to manage data related to a particular vehicle, such as repair orders and work performed on a vehicle, service history of a vehicle, VIN-specific menus, inspections, and repairs performed by non-dealers. A demographic module 416 may operate to manage demographic data, such as customer location, related customer behavior (e.g., similar customers), vehicle demographics, related vehicle trends, and repair trends performed by non-dealers. A metadata module 418 may operate to manage data related to specific vehicle trims and or VINs, such as maintenance schedules, OEM service recommendations, Dealer service recommendations, service options, and repair options. A marketing module 420 may operate to manage data related to marketing, such as customer marketing segment data, unique customer marketing analyses, and data related to promotions, both available and accepted (e.g., promotions designed to get customers back into a dealer for service).

A timeline module 414 may operate to manage data related to all other modules, for example to populate the timeline 226 with data related to past and future service events for a particular vehicle and customer, as well as dealer and manufacturer service intervals and promotions from particular dealers.

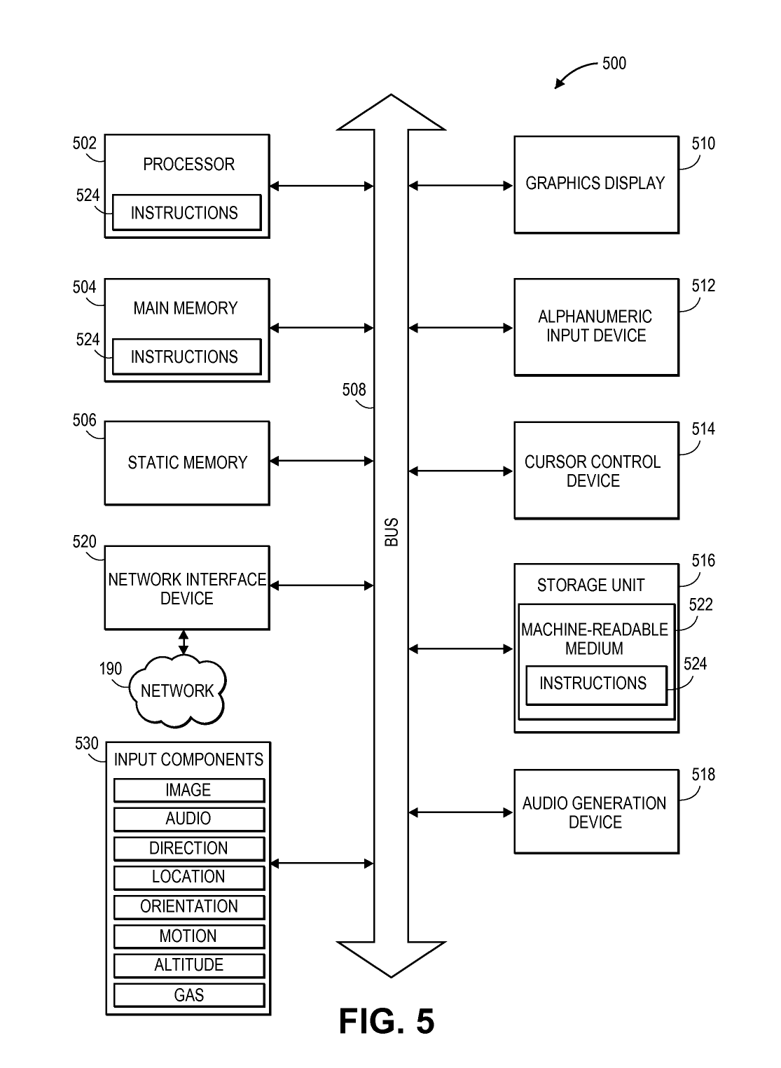

FIG. 5 is a block diagram illustrating components of a machine 500, according to some example embodiments, able to read instructions 524 from a machine-readable medium 522 (e.g., a machine-readable storage medium, a computer-readable storage medium, or any suitable combination thereof) and perform any one or more of the methodologies discussed herein, in whole or in part. Specifically, FIG. 5 shows the machine 500 in the example form of a computer system within which the instructions 524 (e.g., software, a program, an application, an applet, an app, or other executable code) for causing the machine 500 to perform any one or more of the methodologies discussed herein may be executed, in whole or in part. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine is illustrated, the term “machine” shall also be taken to include any collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or other pointing instrument), a storage unit 516, an audio generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media (e.g., tangible and non-transitory machine-readable media). The instructions 524 may be transmitted or received over the network 190 via the network interface device 520. For example, the network interface device 120 may communicate the instructions 524 using any one or more transfer protocols (e.g., hypertext transfer protocol (HTTP)).

In some example embodiments, the machine 500 may be a portable computing device, such as a smart phone or tablet computer, and have one or more additional input components 530 (e.g., sensors or gauges). Examples of such input components 530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

In the description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet or mobile device. The term “mobile device” includes, but is not limited to, a wireless device, a mobile phone, a mobile communication device, a user communication device, personal digital assistant, mobile hand-held computer, a laptop computer, an electronic book reader and reading devices capable of reading electronic contents and/or other types of mobile devices typically carried by individuals and/or having some form of communication capabilities (e.g., wireless, infrared, short-range radio, etc.).

What is claimed is:

1. A method comprising:
receiving a request to view service information for a vehicle;
retrieving data associated with the vehicle based on the request, wherein the data comprises at least one past service event associated with the vehicle;
determining a plurality of future service events based on the data;
generating a plurality of graphical interface elements based on the at least one past service event and the plurality of future service events; and
causing the plurality of graphical interface elements to be displayed along a graphical timeline, wherein the graphical interface elements are associated with dates on the graphical timeline.

2. The method of claim 1, wherein the graphical interface elements to be displayed along the graphical timeline represent a subset of all the past service events associated with the vehicle and the future service events.

3. The method of claim 1, wherein the data associated with the vehicle is retrieved from a plurality of sources.

4. The method of claim 1, wherein determining a plurality of future service events comprises:
determining the vehicle's mileage at the last known service event;
determining the vehicle's current mileage;
calculating a usage rate based upon the difference based on the current mileage, the vehicle's mileage at the last known service event, and the time since the last known service event;
retrieving data describing future service events for the vehicle that are associated with mileage checkpoints greater than the vehicle's current mileage; and
calculating future service events based upon the usage rate.

5. The method of claim 1, further comprising scheduling future service events in response to receiving input associated with the graphical interface elements.

6. The method of claim 1, wherein the data associated with the vehicle comprises service history data for other vehicles related to the vehicle by a common factor.

7. A non-transitory machine-readable storage medium comprising instructions that, when executed by one or more processors of a machine, cause the machine to perform operations comprising:
receiving a request to view service information for a vehicle;
retrieving data associated with the vehicle based on the request, wherein the data comprises at least one past service event associated with the vehicle;
determining a plurality of future service events based on the data;
generating a plurality of graphical interface elements based on the at least one past service event and the plurality of future service events; and
causing the plurality of graphical interface elements to be displayed along a graphical timeline, wherein the graphical interface elements are associated with dates on the graphical timeline.

8. The non-transitory machine-readable storage medium of claim 7, wherein the graphical interface elements to be displayed along the graphical timeline represent a subset of all the past service events associated with the vehicle and the future service events.

9. The non-transitory machine-readable storage medium of claim 7, wherein the data associated with the vehicle is retrieved from a plurality of sources.

10. The non-transitory machine-readable storage medium of claim 7, wherein determining a plurality of future service events comprises:
determining the vehicle's mileage at the last known service event;
determining the vehicle's current mileage;
calculating a usage rate based upon the difference based on the current mileage, the vehicle's mileage at the last known service event, and the time since the last known service event;
retrieving data describing future service events for the vehicle that are associated with mileage checkpoints greater than the vehicle's current mileage; and
calculating future service events based upon the usage rate.

11. The non-transitory machine-readable storage medium of claim 7, further comprising scheduling future service events in response to receiving input associated with the graphical interface elements.

12. The non-transitory machine-readable storage medium of claim 7, wherein the data associated with the vehicle comprises service history data for other vehicles related to the vehicle by a common factor.

13. A system comprising:
a module configured to receive a request to view service information for a vehicle;
a module configured to retrieve data associated with the vehicle based on the request, wherein the data comprises at least one past service event associated with the vehicle;
a module configured to determine a plurality of future service events based on the data;
a module configured to generate a plurality of graphical interface elements based on the at least one past service event and the plurality of future service events; and
a module configured to cause the plurality of graphical interface elements to be displayed along a graphical timeline, wherein the graphical interface elements are associated with dates on the graphical timeline.

14. The system of claim 13, wherein the graphical interface elements to be displayed along the graphical timeline represent a subset of all the past service events associated with the vehicle and the future service events.

15. The system of claim 13, wherein the data associated with the vehicle is retrieved from a plurality of sources.

16. The system of claim 13, wherein determining a plurality of future service events comprises:
determining the vehicle's mileage at the last known service event;
determining the vehicle's current mileage;
calculating a usage rate based upon the difference based on the current mileage, the vehicle's mileage at the last known service event, and the time since the last known service event;
retrieving data describing future service events for the vehicle that are associated with mileage checkpoints greater than the vehicle's current mileage; and
calculating future service events based upon the usage rate.

17. The system of claim 13, further comprising scheduling future service events in response to receiving input associated with the graphical interface elements.

18. The system of claim 13, wherein the data associated with the vehicle comprises service history data for other vehicles related to the vehicle by a common factor.
